(19) United States
(12) Patent Application Publication
(10) Pub. No.: US 2006/0242015 A1
(43) Pub. Date: Oct. 26, 2006

(54) Method of bridge advertising

(76) Inventor: Mark Thompson, Midland, MI (US)

Correspondence Address: MCKELLAR IP LAW, PLLC, 784 SOUTH POSEYVILLE ROAD, MIDLAND, MI, 48640, US

(21) Appl. No.: 11/114,670

(22) Filed: Apr. 26, 2005

(51) Int. Cl. G06Q 30/00

(52) U.S. Cl. 705/14

(57) ABSTRACT

A method of providing advertising on a bridge, and a method of doing business that is a method of bridge advertising. The method requires among other requirements, obtaining the rights from the bridge owners to do the advertising. It also deals with an advertising medium and structure that appear to be unknown and that has not been used to display advertising and provides for an outlet for potential advertisers to advertise their goods and services in places that heretofore have not been used for such purposes.

The invention disclosed and claimed herein deals with a method of providing advertising on a bridge, and a method of doing business that is a method of bridge advertising.

The essence of the invention is a method that requires among other requirements, obtaining the rights from the bridge owners to do the advertising.

The method deals with an advertising medium and structure that appear to be unknown and that has not been used to display advertising and provides for an outlet for potential advertisers to advertise their goods and services in places that heretofore have not been used for such purposes.

### BACKGROUND OF THE INVENTION

The applicant herein is unaware of any prior art that shows or discloses this method of doing business.

Corporations and other entities are taking every opportunity to advertise their goods and services. They are paying huge amounts of money to put their name on everything from entertainment stadiums t sports complexes. The idea of advertising is not new, however, there may be many methods that have not been employed for this purpose before. For example, city buses have had advertising on them for years. Private companies construct billboards wherever they think they can lease them out to an advertiser, and in fact, some new schools are being built, and the classroom names are for sale as an advertising means.

The United States has an immense system of roads and railroads. These systems are owned, for the most part, by the Federal Government, some by States, some by cities, some by counties, some by townships, and villages. The systems are in constant demand for maintenance and improvement. The cost for construction and maintenances is staggering. The bridges in these systems are the most expensive to build and maintain.

It is believed that the method of this invention would provide a revenue stream for the afore-mentioned owners that would enhance a means by which such maintenance and repairs can be undertaken at minimal cost to the owners, in that, some of that cost could be provided by the inventive method herein.

A bridge structure, by its nature, is a ready made billboard, in that there are many sides, ends, pillars, tops, bottoms, that are available for advertisers in all directions of an approach to a bridge, and thus, the placement for advertising on bridges is essentially endless.

It is believed by the inventor herein that potential advertisers would like to take advantage of this opportunity, provided such advertising was available and there was a method that would allow one to access this advertising. Such potential clients would be, for example, boat manufacturers (for underneath the bridge for example), and for example, other manufacturers such as fishing motors, fishing equipment, fishing lines, lures, chain sporting goods stores, and the like, There are also local businesses like bait shops, restaurants, bars, marinas, sporting good shops, and truck dealers that would benefit from such advertising.

Electricity is available on most bridges and this would facilitate the types of advertising that could be undertaken.

Thus, it is contemplated within the scope of this invention to apply this method to all types of bridges, for example, automobile bridges, truck bridges, railroad bridges, pedestrian bridges, and airline ramps, and the like.

Having the bridge structure in place facilitates the installation of advertising structure, if needed, on the bridge.

### THE INVENTION

This invention deals with a method of advertising on bridges, and in another embodiment, it deals with a method of providing advertising on bridges.

With more specificity, this invention deals with a method of providing advertising on a bridge, wherein the method comprises obtaining permission to use a bridge for advertising purposes, providing a written agreement for the use of advertising on the bridge with an advertising client, placing advertising on the bridge structure on behalf of the client, and obtaining payment from the client.

A second embodiment of this invention is a method of doing business, wherein the method comprises locating a bridge owner, contracting with the bridge owner for advertising space on the bridge, locating a potential advertiser, putting the advertiser under contract, and installing advertising on the bridge.

In a third embodiment, the method of doing business contemplates an additional step, that is, managing the advertising.

Yet another embodiment of this invention is a method of doing business wherein there is an additional step, that is, remitting payments to the bridge owner.

Finally, a final embodiment is a method of doing business wherein there is an additional step, that is, refurbishing the advertising space at the end of the contract.

Contemplated within the scope of this invention is a method in which the final embodiment follows the “remitting payments to the bridge owner” step, which in turn, follows the third embodiment.

For purposes of this invention, the step of “obtaining permission to use a bridge” means that one needs to obtain written permission to use a bridge because of the fact that the bridges are not generally public to the extent that the public can not use the bridge for other than its initial intended purpose, that is, crossing over the bridge. Thus, the person intending to use the method for advertising must obtain permission from the owner thereof. This is usually accomplished by putting in place a written agreement between the parties.

In turn, it is a good practice to put in place a written agreement between the parties for placing the advertising, that is a businessman, and a client for the advertising.

The placing of advertising on the bridge structure within the scope of this invention means that one can construct billboards, or can paint directly on the bridge structure, or can place placards, or the like in whatever position on the bridge is desired.

It is imperative that the businessman maintains the advertising on the bridge, and in addition, the businessman needs to remit payments to the bridge owner and after a contract is terminated, the businessman would need to refurbish the advertising space.

What is claimed is:

1. A method of providing advertising on a bridge, the method comprising:
(I) obtaining permission to use a bridge for advertising purposes;
(II) providing a written agreement for the use of advertising on the bridge with an advertising client;
(III) placing advertising on the bridge structure on behalf of the client, and
(IV) obtaining payment for the use of the bridge for advertising from the client.

2. A method of doing business, said method comprising:
(A) locating a bridge owner;
(B) contracting with the bridge owner for advertising space on the bridge;
(C ) locating a potential advertiser;
(D) putting the advertiser under contract, and
(E) installing advertising on the bridge.

3. A method of doing business as claimed in claim 2 wherein there is an additional step (F) manage the advertising.

4. A method of doing business as claimed in claim 3 wherein there is an additional step (G) remitting payments to the bridge owner.

5. A method of doing business as claimed in claim 4 wherein there is an additional step (H) refurbishing the advertising space after the end of the contract.
